(19) United States
(12) Patent Application Publication
(10) Pub. No.: US 2011/0121143 A1
(43) Pub. Date: May 26, 2011

(54) TRACKING SYSTEM

(75) Inventor: Gerd IMKAMP, Gutersloh (DE)

(73) Assignee: SCHUCO INTERNATIONAL KG, Bielefeld (DE)

(21) Appl. No.: 12/854,950

(22) Filed: Aug. 12, 2010

(30) Foreign Application Priority Data
Aug. 14, 2009 (DE) 20 2009 005 140.4
Aug. 14, 2009 (DE) 20 2009 005 141.2

(51) Int. Cl. F16M 11/10; F16M 11/02

(52) U.S. Cl. 248/185.1; 248/178.1

(57) ABSTRACT

Tracking device (1) for a solar element, having a carrier (8) rotatable around an axis, which is rotatable via a drive element (10), and a coupling element (11) fixable on an anchor (2), which has an axial bearing surface (14, 14′) for the carrier (8) and forms a receptacle (16, 16′), into which an anchor (2, 2′, 2″, 2′″′) is insertable and fixable by clamping via fasteners (12, 12′).

The present invention relates to a tracking device for a solar element.

DE 101 92 244 discloses a tracking device for tracking a solar element according to the position of the sun, the solar element being fixed on a frame-shaped carrier. The carrier is held on a further receptacle carrier, which is fixed on a vertical column as an anchor. Such anchors must be designed differently depending on the soil structure. The substrate can vary strongly, so that fixing the vertical columns as anchors can cause difficulties. In addition, the carrier and the receptacle carrier are complicated to install and costly to produce. The carrier for the solar element is mounted on a receptacle carrier so it is pivotable around a horizontal rotational axis and the receptacle carrier is mounted on a vertical column so it is rotatable around a vertical axis. The carrier for the solar element can thus be tracked well to the position of the sun, however, support frame and receptacle carrier have a high intrinsic weight and are costly to produce. The receptacle carrier is assembled in the form of a frame from four profiles, the total weight load loading an upper transverse spar, which can result in significant sagging. The stability against tilting is achieved by a mounting on the lower transverse spar, so that a multitude of mounting steps and components are required. Finally, the disadvantage also exists that the vertical column is especially adapted to the receptacle carrier, which can vary because of different soil structures, however. The installation of the vertical column is thus difficult depending on the substrate.

U.S. Pat. No. 4,295,621 discloses a tracking device, in which a post is installed as an anchor in the soil. A receptacle having a bearing shell is installed in the post on its upper front side. A vertical axis of a rotating framework for the solar carrier is inserted into the bearing shell. The soil-side post and the remaining framework of the tracking device also form a unit in this design, which may be installed poorly in the case of different soil compositions.

It is therefore the object of the present invention to provide a tracking device, which can be readily installed in the case of various soil compositions.

This object is achieved by a tracking device having the features of claim 1.

According to the invention, the tracking device for a solar element comprises a carrier rotatable around an axis, which is rotatable via a drive element, and a coupling element fixable on an anchor, which has an axial bearing surface, a receptacle being implemented, into which an anchor is insertable and is fixable by clamping via fasteners. Through this design, the carrier can be installed flexibly on various anchors, which may be selected depending on the soil composition, via the coupling element. It is not necessary to adapt the carrier to the anchor, but rather the coupling element provides a universal connection between a suitable anchor and the carrier. This increases the capability for pre-finishing and thus the cost-effectiveness.

An anchor in the meaning of the present invention is understood as a fastening in the earth or foundation, i.e., in particular driven piles, screw-in anchors to be screwed into the ground, concrete base posts, concrete foundations, or other elements fixable on the soil, which are connected to the coupling element.

The fasteners are preferably adjustable relative to the receptacle of the coupling element. In particular, the fasteners may be clamped against a surface on the upper section of anchor, in order to thus fix the coupling element and the carrier, which is situated thereon, having the solar element. The geometry of the anchor can be selected freely in broad ranges by the movement of the fasteners relative to the receptacle or the side walls of the coupling element. Depending on the substrate, rod-shaped anchors, profiles, concrete posts, or other anchors may be used.

In one embodiment, the receptacle is implemented as a cavity, into which an upper section of the anchor is insertable. The fastening area is thus situated protected in the cavity, in order to minimize weathering influences. The coupling element can have a hollow profile on the side facing toward the anchor, in which the receptacle is formed. The anchor is thus situated in the hollow profile having an upper section enclosed on all sides.

A threaded hole for a fastener is preferably implemented on at least one side wall situated around the receptacle. The fastener can thus be implemented as a screw, clamping pin, or other fastener which is easy to install on the coupling element.

For stable fastening of the carrier, the coupling element has a bearing journal protruding upward, on which the carrier is plugged. The bearing journal forms a vertical rotational axis, around which the carrier is rotatable.

In a further embodiment, a support frame, on which a solar element is fixed, is held on the carrier.

In order to be able to rotate the carrier smoothly, the coupling element can be produced from plastic and/or metal. It is also possible to implement the axial bearing surface from plastic or to provide it with a friction ring, in order to ensure a smooth rotation of the carrier. A prefinished axial bearing can also be installed on the coupling element.

According to a further aspect of the invention, the tracking device for solar elements comprises a coupling element fixable on an anchor, which is connected via a plug connection to a carrier, on which a support frame having a solar element is fixed. The carrier has at least two arms for supporting the support frame, so that a complex frame construction can be dispensed with in the carrier. In addition, the plug connection between coupling element and carrier may be installed easily. Such a plug connection comprises at least two parts pluggable one into another, which are accordingly easy to install and provide mutual support after the installation. The coupling element can be installed flexibly on various anchor types, which may be designed depending on the substrate. “Anchors” in the meaning of the present application are understood as parts fastened in the ground, i.e., driven piles, screw-in anchors, concrete posts, concrete foundations, or other parts anchored in the ground.

According to a preferred embodiment, the arms on the carrier are situated spreading out upward. The carrier can thus be statically optimized, the angle of the arms to the horizontal being able to lie in a range between 30 and 60°, in particular approximately 45°. The occurring weight loads may thus be dissipated optimally to the coupling element and the anchor. The arms may be situated symmetrically to a central plane on the carrier.

Preferably, the arms have a retainer for the pivotable mounting of the support frame on the ends. The support frame can thus be pivoted not only around a vertical axis, but rather also around a horizontal axis, which further increases the efficiency of the solar element. The retainer can have an open receptacle for inserting a counter bearing of the support frame for simple installation.

For simple production of the arms, they are preferably produced from a metal plate, in particular by stamping and bending. At least one protruding web having openings for the engagement of levers can be implemented on the arms, at least one lever being coupled to the support frame. The support frame can thus be fixed via the lever in a predetermined angular position, the levers also being able to be situated adjustably, in order to pivot the support frame around a horizontal axis.

In a preferred embodiment, the carrier has a vertical bearing journal, which is mounted rotatably on the coupling element. The bearing journal can transmit both weight forces and also lateral horizontal forces to the coupling element, so that a stable support is ensured. Of course, it is also possible to form a vertical bearing journal on the coupling element, which engages in a bush on the carrier, in order to obtain a stable rotational mounting. At least one horizontal axial bearing surface is preferably implemented on the coupling element, on which the carrier is supported.

In order to move the carrier with the solar element, a drive element is preferably provided on the carrier, using which the carrier is rotatable relative to the coupling element. The drive element can be implemented as a disc, on which a belt coupled to a drive is situated. The belt can be implemented as a cable, toothed belt, or another belt, using which the drive element on the carrier is rotatable. A multitude of tracking devices may then be moved together using the belt.

The invention is explained in greater detail hereafter on the basis of multiple exemplary embodiments with reference to the appended drawings. In the figures:

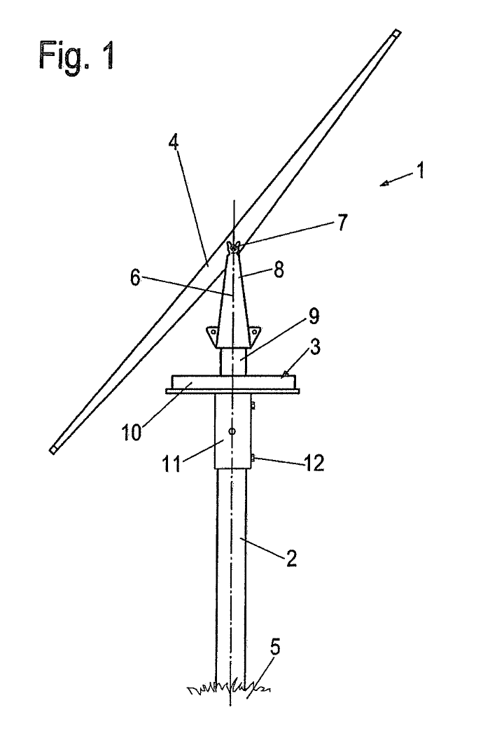

FIG. 1 shows a side view of a tracking device according to the invention;

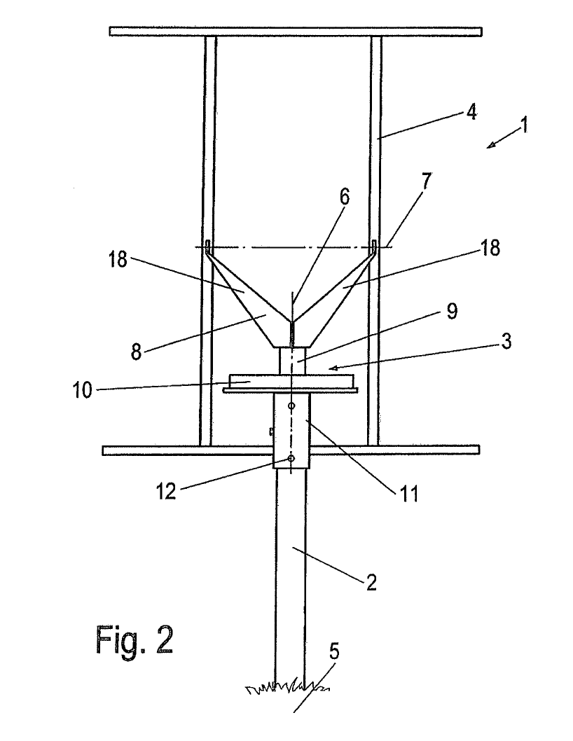

FIG. 2 shows a rear view of the tracking device of FIG. 1;

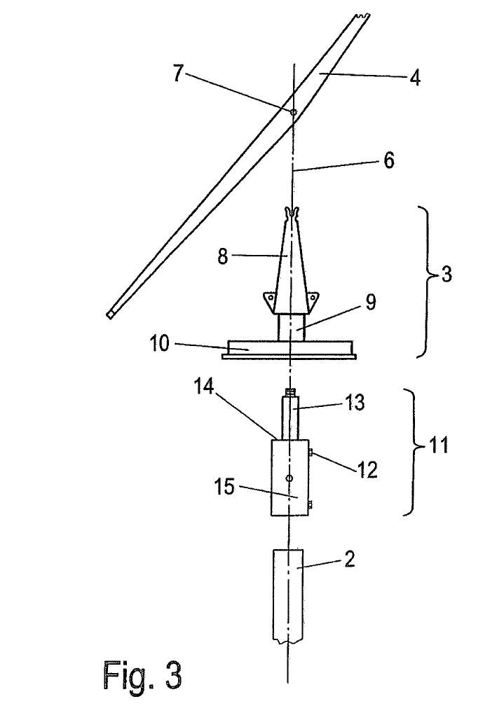

FIG. 3 shows a lateral exploded view of the tracking device of FIG. 1;

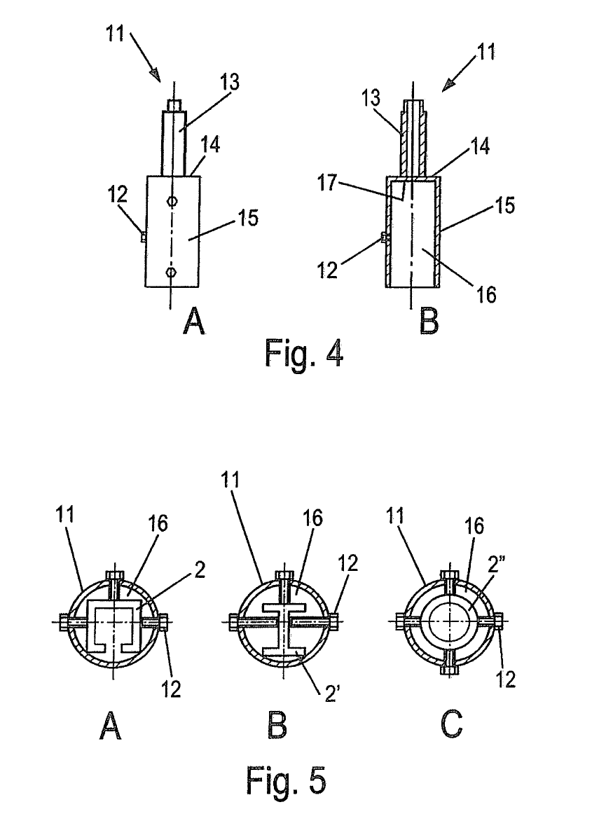

FIGS. 4A and 4B show two views of the coupling element of the tracking device;

FIGS. 5A to 5C show multiple top views of the coupling element of FIG. 4 in various installation positions;

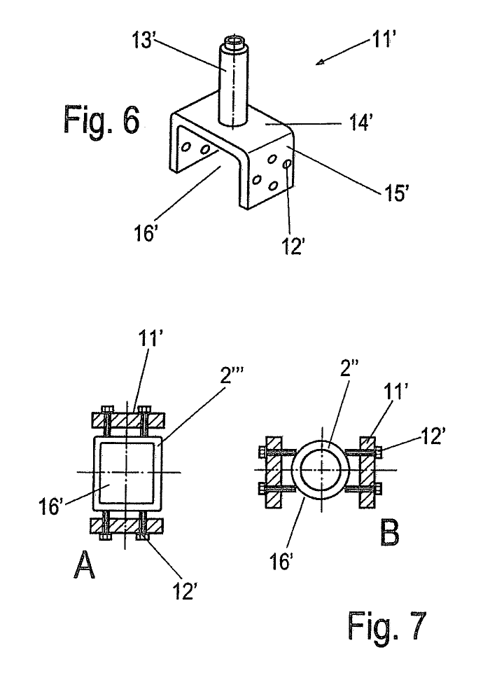

FIG. 6 shows a perspective view of the further exemplary embodiment of a coupling element;

FIGS. 7A and 7B show two top views of the coupling element of FIG. 6 in various installation positions;

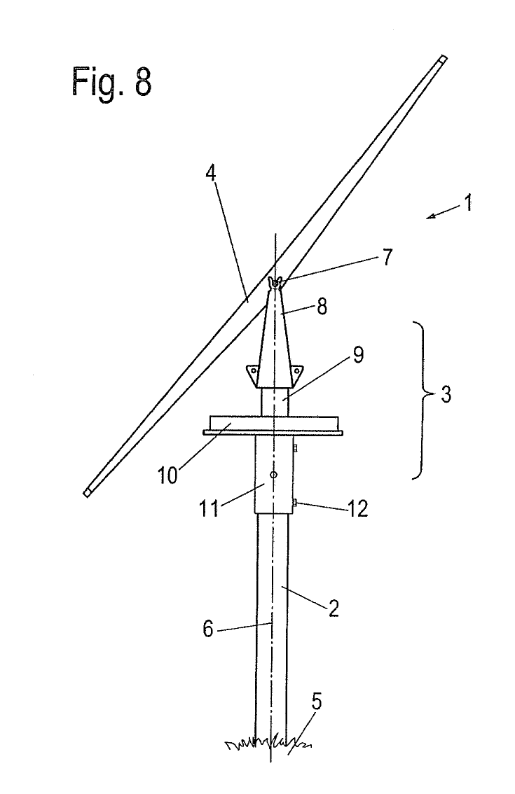

FIG. 8 shows a side view of a further exemplary embodiment of a tracking device;

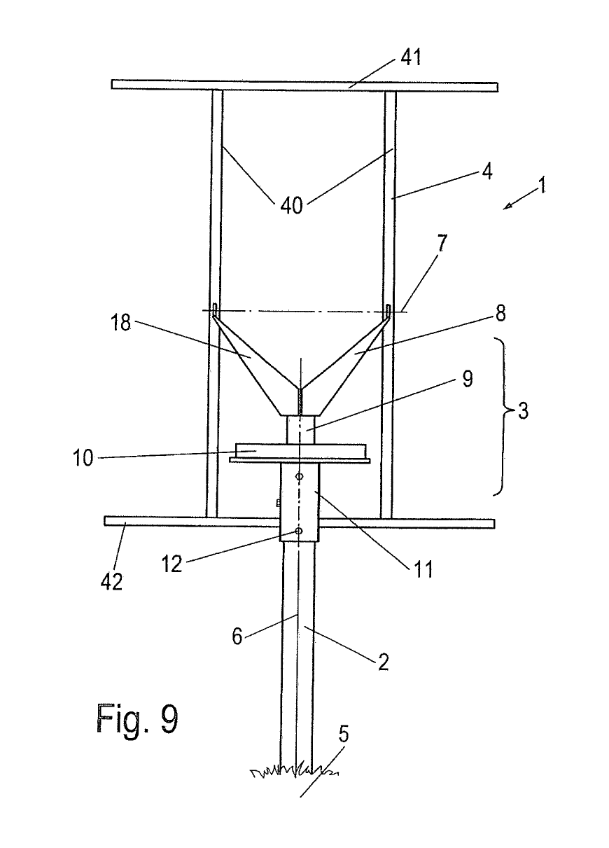

FIG. 9 shows a rear view of the tracking device of FIG. 8;

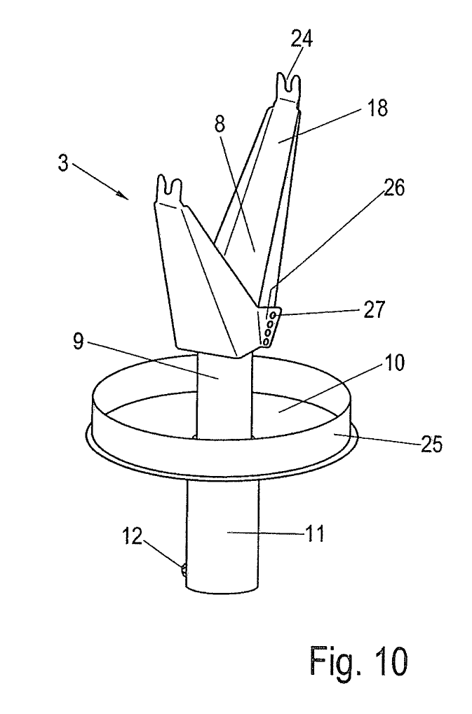

FIG. 10 shows a perspective view of the coupling element and the carrier of the tracking device of FIG. 8, and

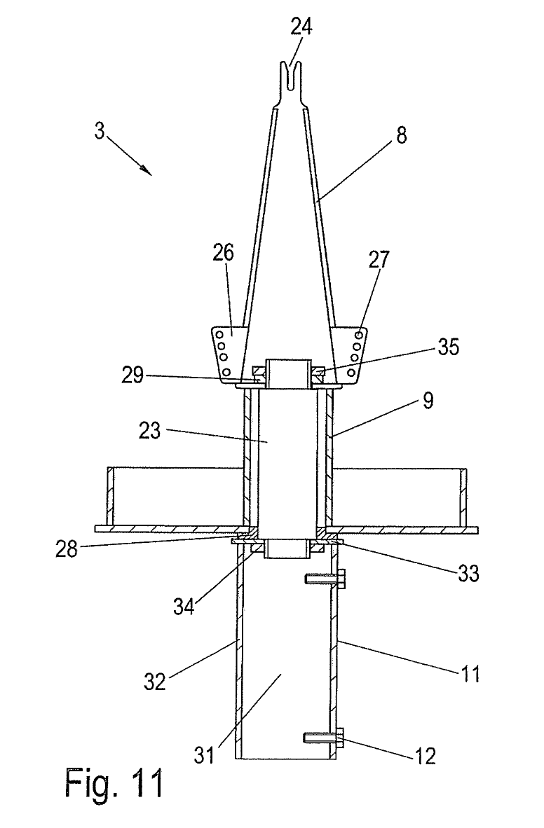

FIG. 11 shows a sectional side view of the carrier and the coupling element of FIG. 10.

A tracking device 1 is installed on an anchor 2, which is fixed in the soil 5. The anchor 2 can be implemented as a post made of concrete or steel, a profile, or another part which is anchored in the soil 5.

The tracking device 1 is used for retaining a support frame 4 for a solar element, which can be implemented as a collector, absorber, reflector, or photovoltaic module.

The support frame 4 is mounted on a rotating framework 3 so it is rotatable around a vertical axis 6, the rotating framework 3 comprising a carrier 8, which is supported on a coupling element 11. The rotating framework 3 can rotate the carrier 8 around the axis 6, in order to track the solar element to the course of the sun (setting of the azimuth). The support frame 4 can be mounted so it is pivotable around a horizontal axis 7, which makes the installation easier. Optionally, the support frame 4 can also be pivoted around a horizontal axis 7 via levers (setting of the elevation), in order to track the solar elements to the solar elevation.

The carrier 8 comprises two arms 18, which protrude upward in a V-shape, and on which the support frame 4 for the solar element is fixed at the ends. The arms 18 protrude upward at an angle of approximately 45° and hold the support frame 4 so it is alternately pivotable around the horizontal axis 7 or fixes the support frame 4 at a desired angle. The support frame 4 is used to receive solar elements, which have a size between 4 and 10 m², preferably between 5 and 7 m². The arms 18 are preferably produced as steel stamped-bent parts.

The carrier 8 is held on a vertical bearing 9, on which a drive wheel 10 is situated. By rotating the drive wheel 10, the carrier 8 may be rotated with the support frame 4 around the vertical axis 6. A pulling cable can be provided on the drive wheel 10, which is coupled to a drive. Instead of the pulling cable, other traction elements, gearwheels, toothed belts, etc. may also be used for the drive of the drive wheel 10. In particular, a multitude of drive elements 10 of multiple tracking devices 1 may be coupled to one another via one drive element.

In order to be able to install the rotating framework 3 with the rotatable carrier 8 and the coupling element 11 on various anchors 2, a universal coupling element 11 is used, which is fixable on various types of anchors 2. The coupling element 11 shown in FIG. 3 comprises an upwardly protruding bearing journal 13, on which the carrier 8 having the hollow bearing 9 is plugged. A horizontal bearing surface 14 is formed at the lower end of the bearing journal 13, which is formed as the axial bearing and on which a bearing surface of the bearing 9 and/or the drive element 10 rests.

On the side facing toward the anchor 2, the coupling element 11 has a retainer having side walls 15, which is implemented as a cylindrical bush. Fasteners 12 in the form of threaded bolts are situated on the side walls 15, which are screwed into corresponding threaded openings in the side walls 15.

The coupling element 11 is shown in FIG. 4 in the detail which forms an axial bearing surface 14 in a central area between the bearing journal 13 and the side walls 15. It is also possible to provide a bearing ring on the axial bearing surface 14, which is then a component of the coupling element 11. The side walls 15 enclose a cylindrical receptacle 16, into which an upper section of an anchor 2 is insertable.

Various installation examples of the coupling element 11 in the area of the receptacle 16 are shown in FIGS. 5A to 5C. In FIG. 5A, a partially open square profile is provided as the anchor 2, which is situated in the receptacle 16. The anchor 2 is situated with play in the receptacle 16 and is fixed in the receptacle 16 via the fasteners 12, which are implemented as screws. For this purpose, the screws are screwed into the side walls 15 until their front edges press against the anchor 2 and the coupling element 11 is thus fixed by clamping. The weight forces are transmitted via the coupling element 11 through a front side 17, which rests on top on the anchor 2.

In FIG. 5B, an anchor 2′ is implemented as a double T-profile and the coupling element 11 can also be fixed identically in this embodiment of the anchor 2′. The fasteners 12 are clamped on the outer faces of the anchor 2′, while a front side 17 of the coupling element 11 rests on the anchor 2′.

In FIG. 5C, an anchor 2″ is implemented as a circular hollow profile, which can also be fixed on the coupling element 11. The anchor 2″ is situated with play in the receptacle 16 and is fixedly clamped via the fasteners 12.

A modified embodiment of a coupling element 11′ is shown in FIG. 6, which has an upwardly vertically protruding bearing journal 13′. A horizontal contact surface 14′ is implemented on the bottom end of the bearing journal 13′, which is used as the axial bearing for the carrier 8. The carrier 8 can be implemented as in the first exemplary embodiment.

In the lower area, the coupling element 11′ has two flat side walls 15′, which are spaced apart from one another, and between which a receptacle 16′ is situated. Multiple fasteners 12′ for fixing the coupling element 11′ on an anchor are provided in the side walls 15′.

The coupling element 11′ is shown on various anchors in FIGS. 7A and 7B. In FIG. 7A, a closed square profile is provided as the anchor 2′″, an upper section of the anchor 2′″ being inserted into the receptacle 16′ and the coupling element 11′ resting on the anchor 2′″. For lateral stability, the fasteners 12′ are fixed by clamping on the anchor 2′″.

A circular anchor 2″ is provided in FIG. 7B, on which the fasteners 12′ of the coupling element 11′ are fixed.

Through the configuration of a coupling element 11 or 11′ between the carrier 8 and anchor 2, 2′, 2″, 2′″, the tracking device can be prefinished independently of the actual design of the anchor. The particular anchor 2, 2′, 2″, 2′″ may be set up and anchored in the soil depending on the soil composition, so that a solar power plant can be set up via the universal coupling element 11 or 11′ in a short time.

A further exemplary embodiment of a tracking device 1 for solar elements is shown in FIGS. 8 to 11, which is installed on an anchor 2 fastened in the ground 5. The anchor 2 can be implemented as a driven pile, screw-in anchor, steel profile, concrete post, or concrete foundation.

The tracking device 1 comprises a rotating framework 3, which has a coupling element 11 and a carrier 8. A support frame 4 is supported on the carrier 8, on which a solar element is retained. The solar element can be implemented as a collector, absorber, reflector, or photovoltaic module, which tracks the position of the sun. The support frame 4 comprises two struts 40, which are spaced apart from one another, and which are connected to one another via an upper horizontal transverse strut 41 and a lower horizontal transverse strut 42. The fastening of the solar module can be performed via corresponding fasteners on the struts 40, 41, and 42 of the support frame 4. Solar elements having an area between 4 and 10 m², in particular 5 and 7 m², can be installed on the support frame 4.

The carrier 8 comprises two upwardly spread-out arms 18, on each of whose ends an upwardly open receptacle 14 is implemented, in which a journal of the support frame 4 is insertable. The support frame 4 can thus be simply laid thereon, which simplifies the installation. The arms 18 protrude upward at an angle between 30° and 60° and are situated symmetrically to a central plane with the vertical axis 6. The support frame 4 is thus mounted so it is pivotable around a horizontal axis 7 on the two receptacles 14.

The carrier 8 having the support frame 4 is mounted so it is rotatable around a vertical axis 6. For this purpose, the carrier 8 comprises a vertical bearing journal 9 on the side facing toward the coupling element 11, which is coupled via a plug connection with the coupling element 11. A disc 10 is situated rotationally fixed on the bearing journal 9, which is used as a drive element and to which a belt (not shown) is connected, in order to rotate the carrier 8 having the solar element. The belt can rotatably drive a multitude of tracking devices having carriers 8. The belt can be implemented as a toothed belt, cable, or another drive belt.

The carrier 8 and the coupling element 11 are shown in detail in FIGS. 10 and 11. On the lower side facing toward the anchor 2, the coupling element 11 has a hollow profile 32, which has an inner receptacle 31. Threaded openings are implemented on the side walls of the hollow profile 32, into which fasteners 12 in the form of screws, threaded bolts, or other fastening elements are screwed. An upper section of the anchor 2 can thus be fixed by clamping on the coupling element. Because of the multitude of various anchors 2, which may vary depending on the soil composition, the coupling element 11 can be fixed by clamping on the anchor 2 substantially universally via the fasteners.

On its upper end, the hollow profile 32 has a cover 33, on which an axial bearing 28 is situated. The axial bearing 28 can be implemented as a roller bearing, friction ring, or another axial bearing, on which the bearing journal 9 of the carrier 8 is supported. Both vertical forces and also horizontal forces may be transmitted on the axial bearing 28.

The coupling element 11 has a guide journal 23, which protrudes vertically upward and is supported on the lower end on the cover 33. Furthermore, the guide journal 23 is clamped via a nut 34 on the cover 33. The guide journal 23 is used for guiding the carrier 8 and has a bearing 29, which is installed on a central section of the carrier 8. The carrier 8 is thus held via the bearing 29 and the axial bearing 28 on the coupling element 11, so that a stable support is ensured. The bearing 29 can be fixed via a nut 35 on the guide journal 23.

The carrier 8 has horizontally and radially protruding webs 26, on which openings 27 are formed, in the area adjacent to the bearing 29. Levers (not shown) are installable in the openings 27, which support the support frame 4. Pivoting of the support frame 4 around the axis 7 can be performed via the levers or a predetermined angular position of the support frame 4 around the axis 7 is fixed.

The drive element 10 has a cylindrical outer surface 25, on which engagement means for the drive belt are implemented.

In the illustrated exemplary embodiment, the carriers 8 are produced from stamped and bent metal plates, which have two arms 18 having essentially U-shaped cross-section. Of course, it is also possible to implement the arms 18 of the carrier 8 differently.

1. A tracking device for a solar element, having a carrier rotatable around an axis, which is rotatable via a drive element, and a coupling element fixable on an anchor, which has an axial bearing surface for the carrier and forms a receptacle, into which an anchor is insertable and is fixable by clamping via fasteners.

2. The tracking device according to claim 1, characterized in that the fasteners are adjustable relative to the receptacle of the coupling element.

3. The tracking device according to claim 1, characterized in that the receptacle is implemented as a cavity, into which an upper section of the anchor is insertable.

4. The tracking device according to claim 1, characterized in that the coupling element has a hollow profile, in which the receptacle is formed, on the side facing toward the anchor.

5. The tracking device according to claim 1, characterized in that an opening, in particular a threaded opening, for a fastener, is formed on at least one side wall enclosing the receptacle.

6. The tracking device according to claim 1, characterized in that the coupling element has an upwardly protruding bearing journal, on which the carrier is plugged.

7. The tracking device according to claim 1, characterized in that a horizontal axial bearing surface, on which the rotatable carrier, is implemented on the coupling element.

8. The tracking device according to claim 1, characterized in that a support frame, on which a solar element is fixed, is held on the carrier.

9. The tracking device according to claim 1, characterized in that the coupling element has an axial bearing surface made of plastic.

10. A tracking device for solar elements, having a coupling element fixable on an anchor, which is connected via a plug connection to a carrier, on which a support frame having a solar element is fixed, the carrier having at least two arms for supporting the support frame.

11. The tracking device according to claim 10, characterized in that the arms are situated spread out upward on the carrier.

12. The tracking device according to claim 10, characterized in that the arms have a retainer on the ends for the pivotable mounting of the support frame.

13. The tracking device according to claim 12, characterized in that the retainer has an open receptacle for inserting a counter bearing of the support frame.

14. The tracking device according to claim 10, characterized in that the arms are produced from a metal plate.

15. The tracking device according to claim 10, characterized in that at least one protruding web having openings for engagement using levers is formed on the arms, at least one lever being coupled to the support frame.

16. The tracking device according to claim 10, characterized in that the carrier has a vertical bearing journal, which is mounted so it is rotatable on the coupling element.

17. The tracking device according to claim 10, characterized in that a horizontal axial bearing surface, on which the carrier is supported, is implemented on the coupling element.

18. The tracking device according to claim 10, characterized in that a drive element is provided on the carrier, using which the carrier (8)-is rotatable relative to the coupling element.

19. The tracking device according to claim 18, characterized in that the drive element is implemented as a disc, on which a belt coupled to a drive is situated.
